(19) United States
(12) Patent Application Publication
(10) Pub. No.: US 2010/0076885 A1
(43) Pub. Date: Mar. 25, 2010

(54) CLEARING AND SETTLEMENT OF TRADES IN OVER THE COUNTER MARKETS

(76) Inventors: Jesse R. Drennan, Lindenhurst, NY (US); Jerome Bayer, Oak Ridge, NJ (US)

Correspondence Address: DICKSTEIN SHAPIRO LLP, 1633 Broadway, NEW YORK, NY, 10019, US

(21) Appl. No.: 12/533,662

(22) Filed: Jul. 31, 2009

Related U.S. Application Data
(60) Provisional application No. 61/085,606, filed on Aug. 1, 2008.

(51) Int. Cl. G06Q 40/00

(52) U.S. Cl. 705/37

(57) ABSTRACT

A post-trade settlement system matches trade tickets relating to trades executed on a trading system or by another means. Matched trades are novated by executing a trade for the volume and price of the matched trade between a first counterparty and the settlement system and an equal but opposite trade between the settlement system and the second counterparty to the trade. The positions of each counterparty are continuously netted. There is no physical settlement of the positions but profit and loss is transferred periodically. If physical settlement is required a notice of interest is sent and a counterparty identified. A settlement swap is then executed between the settlement system and the two counterparties to the physical settlement. The settlement swap moves the position to be settled physically from the settlement system to each of the counterparties whereupon the amount moved can be settled by a transfer from one counterparty to the other.

### CROSS REFERENCE TO RELATED APPLICATION

This is a Utility Application claiming benefit under 35 USC 119(e) of provisional application Ser. No. 61/085,606, filed on Aug. 1, 2008, which is hereby incorporated herein by reference.

### FIELD OF THE INVENTION

This invention relates to settlement systems and processes and particularly relates to the clearing of trades conducted in OTC (Over the Counter) markets.

### BACKGROUND TO THE INVENTION

OTC markets allow counterparties to buy and sell items directly without a central exchange to facilitate market making. The FX (Foreign Exchange) market is one example of an OTC market.

The FX markets have developed significantly in recent years. Historically, FX trades were conducted through voice brokers. While voice brokers still exist, much of the present market is traded through professional electronic platforms such as the EBS platform provided by ICAP Plc of London, United Kingdom. This platform provides anonymous matching of orders to banks, hedge funds and other institutions with the counterparty's name disclosed after an order is matched and a trade executed. Electronic platforms originally relied on human traders to input orders but now include algorithmic traders which are computer terminals that monitor the market and input buy and sell orders in response to market conditions in a manner dictated by the trading algorithm which they are programmed to execute.

Traditionally, credit on electronic platforms has been handled by extending bilateral credit limits such that trades will not be executed unless both parties have sufficient credit with each other. Credit checking is an integral part of the anonymous electronic trading process. More recently, prime brokerage has been introduced which enables parties with limited credit to benefit from the credit of prime brokers to transact trades that would otherwise not be available to them.

Confirmation of trades has evolved from voice checkouts to fax and paper confirms through the use of electronic confirmation systems such as SWIFT. However, an underlying assumption of all approaches to settlement has always been that there will be a physical exchange of the currencies traded. Netting systems exist which net counterparties' obligations to each other every trading day so that only a single payment per currency need to be made even if there have been multiple trades. However, there is still a physical transfer. An example of a netting system is the Harmony NetLink™ system provided by Traiana, Inc of Tel Aviv, Israel.

We have appreciated that foreign exchange markets have changed fundamentally and that existing settlement systems are no longer appropriate to the needs of trading parties. Many FX trades are made for purely financial purposes. These may be made for speculative reasons by traders hoping to benefit from changes in the price of the currency pairs they are trading. These trades do not require physical settlement and FX may be considered to be an asset in its own right. Of course, there are still many trades performed where the transaction is driven by a commercial need and physical settlement is required. However, this is not the case for a large proportion of trades. The requirement to have a physical movement of cash for all trades gives rise to a number of serious problems. Firstly, it greatly increases market risk, that is the risk of one party to a transaction defaulting between the time at which the trade was executed and the time when settlement is required, which is typically 2 days in the FX spot markets. Secondly, physical settlement creates a vast overhead of operational risk, which is unnecessary. Thirdly, physical settlement of speculative positions causes a great deal of unnecessary noise, which can mask underlying issues in the commercial flow, which may go unnoticed.

There is therefore a need to provide an alternative method of settling transactions which addresses the problems discussed above.

US 2008/0071664 assigned to Chicago Mercantile Exchange, Inc and Reuters America, Inc discloses the use of a central counterparty in a settlement system. This central counterparty novates trades between counterparties and interposes itself as the entity with whom each counterparty will settle. Thus, a trade between two counterparties A and B will be novated as a trade between counterparty A and the central counterparty and an equal and opposite trade between the central counterparty and counterparty B. This system is described as eliminating or limiting counterparty risk, but requires credit or collateral from at least some of the counterparties to ensure that the central counterparty does not assume an unaddressed risk. Counterparty risk may include a lack of credit in a system, which does not include credit checking as part of its trade execution process; a failure to instruct settlement; and a failure to effect settlement. The latter can be caused by a number of factors including inadvertent error and a disputed trade.

The system of US 2008/0071664 is intended to bridge the gap between settlement of exchange traded instruments and settlement of OTC traded instruments. Settlement of OTC trades is considered to be much more risky and the use of a central counterparty is described as reducing that risk and bringing some of the benefits of exchange trading to OTC markets. One of these benefits is to facilitate access to the markets by new counterparties. In some OTC markets, a new counterparty cannot trade until credit has been extended to them by existing counterparties. These lines of credit will not be extended until the existing counterparties are satisfied at the credit worthiness of the new entrant. This is considered to hinder the development and growth of OTC markets.

Although the use of a central counterparty addresses some aspects of risk management, the system described in US 2008/007164 does not distinguish between trades where physical settlement is required and purely speculative trades.

### SUMMARY OF THE INVENTION

The present invention aims to address the various problems described above. One aspect of the invention resides in a system and method for clearing trades which uses a central counterparty but which does not involve any physical transfer of the underlying currency unless specifically requested by either or both the counterparties to a trade.

Another aspect of the invention resides in a system and method for clearing trades in which a central counterparty is used and positions are rolled against a common currency.

A further aspect of the invention provides a mechanism for physical settlement within a central counterparty system, which uses cash settlement as its default settlement regime. This physical settlement regime uses a settlement swap that responds to a request for physical settlement by executing a trade between the central counterparty and the counterparty submitting the request.

More specifically, an embodiment of the invention resides in a post-trade system and method for settlement of transactions in which trade related data is received from trading parties and which identifies executed trades. The data includes the identity of the counterparties to the trades, the items traded, the value date and the price and amount of the trades. This information may be provided as a deal ticket. For each executed trade, trade related data received from counterparties to a trade is matched to identify a matched trade between first and second counterparties. For a given trade this may involve matching the deal tickets submitted by the two parties to the trade. The trade is then novated into a first trade between the first counterparty and the settlement system and a second trade between the second counterparty and the settlement system. A request from a party to a novated trade is then received which asks for physical settlement of part or all of the net position. A first and second counterparty to the physical settlement are determined and a settlement swap is executed against a common currency at current market rates. This involves moving an equal and opposite position from the settlement system to the first and second counterparties to the settlement request. This is done as separate deals. The amounts may then be settled by transfer between the first and second counterparties.

Embodiments of the invention have the advantage that settlement may be made on a cash basis with no physical settlement unless specifically requested. This greatly reduces settlement risk and operational risk. The settlement swap mechanism enables physical settlement to take place if desired. The settlement system may be used with a variety of trading systems and can settle trades regardless of the platform on which they were executed.

Embodiments of the invention have the further advantage that as there is no physical settlement unless requested, positions may be rolled against a common currency, for example US$. The central counterparty decomposes traded currency pairs against the common currency and then rolls positions. This enables the system to benefit from use of a common currency that has greatest liquidity.

Embodiments of the invention have the further advantage that settlement, when required, is by position request per currency, allowing trading decisions to be based on liquidity and not settlement requirements. For example, a client may need to buy CHF and sell USD but liquidity for CHF is much better in a EUR/CHF trade. If a firm then needs to physically settle the CHF with the client it can request a settlement swap in CHF against the common currency (USD) to meet this requirement provided the EUR/CHF trade was executed as an eligible settlement system trade. This is possible as the net settlement positions are maintained against a common currency in effect decomposing both sides of a trade to be against the common currency when one side of the trade is not that currency.

### BRIEF DESCRIPTION OF DRAWINGS

Embodiments of the invention will now be described, by way of example only and with reference to the accompanying drawings, in which:

FIG. 1 is a schematic view of a trading system and a settlement system embodying the invention.

FIG. 2 is a schematic view of a central counterparty settlement system embodying the invention;

FIG. 3 shows the give in of trades to the central counterparty;

FIG. 4 shows the execution of a settlement swap to ensure physical settlement of trades; and

FIG. 5 shows an end of day position roll.

### DESCRIPTION OF PREFERRED EMBODIMENTS

The settlement system embodying the invention is a central counterparty system but the nature of the trading system with which it interacts is not important. The trading system could be an anonymous matching system such as the ICAP® EBS® system. Alternatively it could be a conversational trading system where parties trade in response to RFQs (requests for quotes) from other parties trading on the system. The trading system could itself use a central counterparty. The system is suitable for use in settling trade originating from a number of different trading systems and from non-automated sources. However, the nature of the trading system is outside the scope of the invention. The central counterparty settlement system embodying the invention is described for settlement of FX trades, for example FX spot trades. However, the invention is not limited to the trading of any particular financial instrument and may be used to settle trades of any financial instrument, commodity or other item that is traded in an over-the-counter (OTC) market.

Once a trade has been executed on the trading system, a trade ticket will be generated by the system for each of the counterparties to the trade. The trade tickets will be sent to the counterparties by the system for processing. In the ICAP EBS system referred to above, this is achieved by the DealFeed™ system, which provides an electronic interface between the trading platform and the settlement system. A DealFeed server generates trade tickets, which include settlement information and counterparty information. These trade tickets are received by a client terminal at the counterparty trading floor.

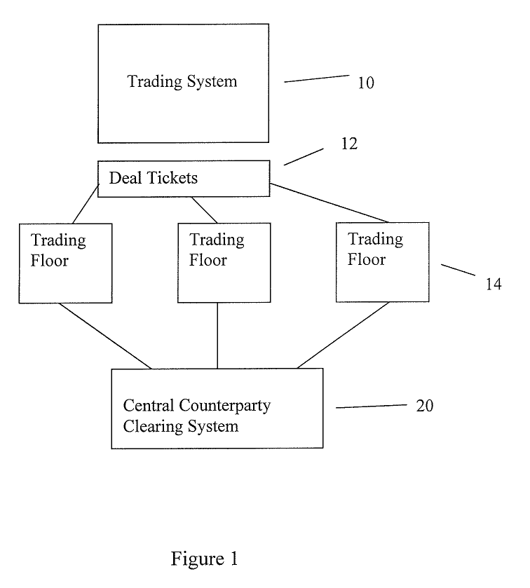

The central counterparty shown in FIG. 1 captures trade details from the trading system. Where that system is the ICAP EBS platform, that may be by receipt of tickets through the DealFeed system but it could be by any means. In FIG. 1 a trading system is shown generally at 10. Trading tickets 12 resulting from trades are communicated to trading floors 14 and then submitted by the trading floors to the central counterparty clearing system 20.

The central counterparty is not a party to the trade. The central counterparty only becomes involved in settling an existing trade between two counterparties. Thus, no matter where the trade is executed, factors such as the existence of bilateral counterparty credit are dealt with pre-trade and are outside the ambit of the central counterparty.

After the trade has been executed, the counterparties to the trade give up the trade to the central counterparty clearing system. On receipt of the give-up, that is a notification of a trade, the central counterparty reconciles between submitting parties. For any given trade there should be two matching and opposite trade tickets from the two counterparties. For example, where bank A has sold to bank B $30 mm, in the $:£ market there should be a ticket from bank A identifying bank B as the counterparty, $:£ as the instrument, $30 mm as the amount, the value date agreed, the exchange rate, and the transaction as a sell. There should be a ticket from bank B identifying Bank A as the counterparty, $:£ as the instrument, $30 mm as the amount, the value date agreed, the exchange rate, and the transaction as a buy.

The central counterparty will notify both parties of confirmation of receipt of the trade and then step in as counterparty. As in any settlement system there will be mismatches where only one side to a trade is received or where the details received from two parties do not fully match. These mismatches may be dealt with by an exception processing process, which will manage the ageing of unclaimed trades and flag inconsistent trade details.

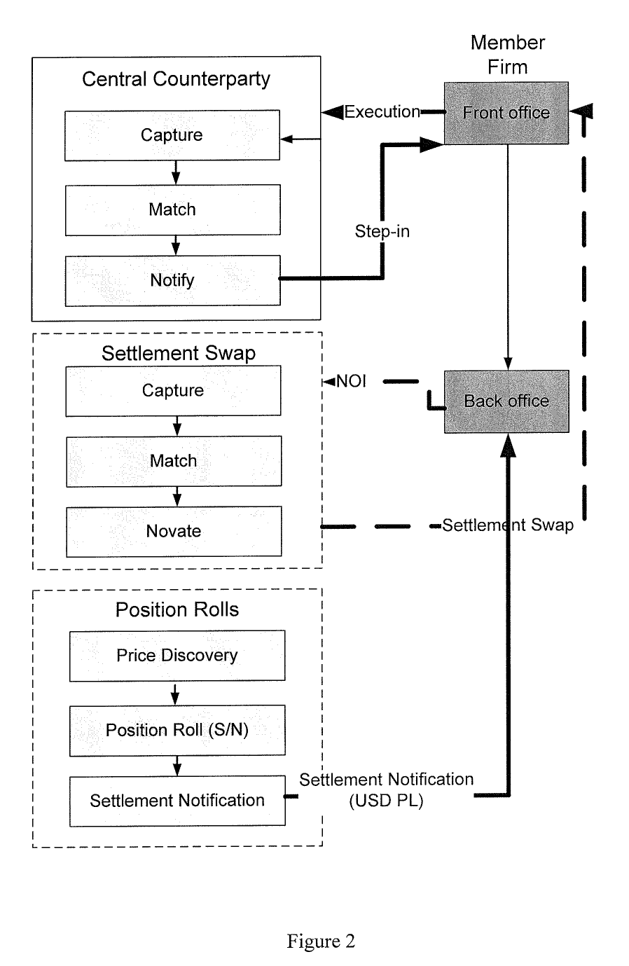

FIG. 2 shows a schematic view of the processes performed by the central counterparty and its interaction with the trading system and the counterparties to trades. It will be appreciated that, in addition to the systems exemplified above, the trading systems from which deal tickets are received need not be automated and the trades may have been made, for example, via a voice broker.

In FIG. 2, the basic functions of the central counterparty 100 are shown as deal capture 102, matching of both sides of the deal from deal execution information received from the parties to a trade 104, and notification of receipt to parties 106.

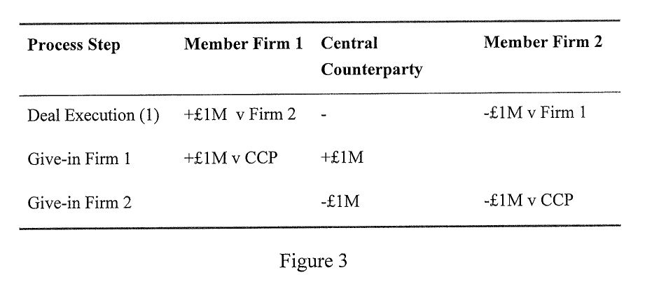

Deal tickets, or notifications of trades, are received from the front offices 108 of member firms. A member firm is a trading party who has agreed to use the central counterparty system for clearance of their trades. Once the trade has been matched, the central counterparty steps in to the trade replacing the existing counterparty. Thus, for a deal between two firms, firm 1 and firm 2, the central counterparty novates each side of the deal so that it becomes a first deal between firm 1 and the counterparty and a second deal between firm 2 and the counterparty. This approach is illustrated in FIG. 3 where the deal executed between firms 1 and 2 involved firm 1 buying £1 mm from firm 2. The central party novates this deal to a £1 mm buy by firm 1 from the central counterparty shown at 110 and a £1 mm sell by firm 2 to the central counterparty shown at 112. The net position of the central counterparty is zero. The step in by the central counterparty is notified back to the counterparties' front offices at step 114 in FIG. 2.

The central counterparty runs continuous net settlement positions (NSP) for accepted trades with the NSP for each member firm updated on acceptance of the trade. There is no physical delivery of the amounts traded and the central counterparty only requires movement of the profit/loss between members rather than the full movement of their currency positions. In prior art systems this could only be achieved using an FX contract such as an NDF (non-deliverable forward) or a CFD (contract for difference).

In some situations, one or both the parties to a trade will want to exchange the physical currency that has been traded. The default position of the settlement system is that there is no physical exchange. The NSPs are rolled against a common currency. Thus, the central counterparty decomposes traded currency pairs against the common currency, in this preferred embodiment the US$ although a different common currency could be selected. The common currency is preferably chosen as that which has greatest liquidity.

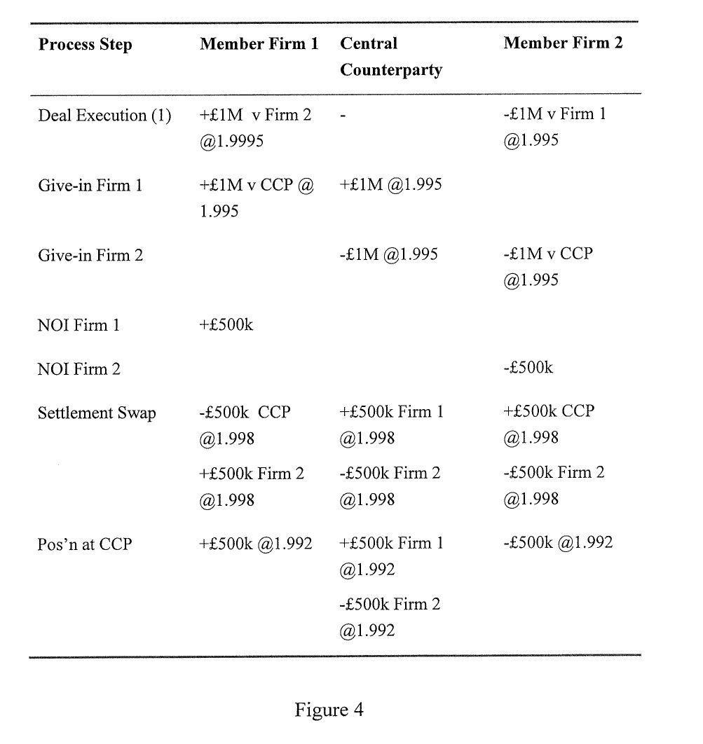

The manner by which physical exchange is performed is referred to as a settlement swap and is illustrated in FIG. 2 and FIG. 4. In FIG. 4, the first three process steps are the same as FIG. 3 and will not be described again. The purpose of the settlement swap is to identify trades where physical delivery is required. This may be achieved by one or both of the parties submitting a request for physical delivery to the central counterparty. This request is referred to as a Notification of Interest (NoI) and is sent by a member 120 (FIG. 2) to the central counterparty where it is received and captured at process step 122. The settlement swap effectively reverses novated NSP's to the central counterparty.

At step 124, the central counterparty will attempt to match NoIs received from members so that the only physical delivery required involves parties that have requested physical delivery. However, matching interest between parties may not be possible and if it is not possible the central counterparty may require delivery from another member. Thus, although the parties do not expect physical settlement, it may be imposed as one or more members to meet the requirements of a party who requires physical delivery.

Referring to FIG. 4, the illustrative position assumes that firms 1 and 2 have filed NoIs asking that their positions be turned into physical delivery positions. This requires the positions to be novated and this action is the settlement swap.

Thus, in FIG. 4, at steps 130 and 132, firms 1 and 2 respectively file NoIs for £500,000. The NoI for firm 1 is entered as +£500K and the NoI for firm 2 as −£500K indicating that firm 2 will transfer £500K to firm 1 with the common settlement currency also being transferred based on market rates at the time of the settlement swap. It will be recalled that there is no longer any deal between firms 1 and 2 nor would there have been a need for firms 1 and 2 to have been direct participants to the NSP, as their positions were novated so that the central counterparty became the counterparty to each of firms 1 and 2. The settlement swap allows firms 1 and 2 to establish a direct trade between themselves effectively reversing part or all of their NSP. Thus, at steps 134, an offsetting position is booked at the central counterparty and the same position is then booked to the member firm with whom the notice of interest was paired. The position at the central counterparty is shown at step 138. Thus, the settlement swap is a three party swap in which a dealer moves a currency position from the cash settle market of the central counterparty to the traditional physically settled market.

Thus, in FIG. 4, there are three deals: first, firm 1 sells £500K to the central counterparty; second, firm 2 buys £500K from the central counterparty; and third, firm 2 sell £500K to firm 1, all against a common currency. As all three deals take place at the same price, the net position at the central counterparty is zero and the net position at both firms is also zero Since this now establishes new financial obligations between the parties to the trade, all activity is done at current market prices. Thus in FIG. 4 the current market price is 1.998. This rate is completely unrelated to the rate at which the original trades were done. Thus, the settlement swap may be viewed as a new trade.

The central counterparty must find a match for an NoI and it is assumed that there is no preference for the credit intermediary provided bi-lateral credit is available

It is preferred that when matching NoIs, intercompany flow is matched first. Thus, an NoI from two trading floors of the same bank in different countries would be matched first. After that, a matching algorithm may be run to optimise matching.

The settlement swap process may be performed periodically, for example, once per day. Once completed the parties will be notified of fill events and booking events created between the parties. Thus, the deals between firm 1 and both the central counterparty will be booked from firm 1's perspective and the deals between firm 2 and firm 1 and the central counterparty will be booked from firm 2's perspective.

Returning to FIG. 2, the settlement swap novation is shown as step 126.

The settlement system operates under continuous net settlement at the central counterparty. Thus, member firms cannot novate a larger position than they have with the central counterparty.

In a CFD system, positions are closed out at the end of each day and then re-established to enable positions to be maintained. Instead, a preferred embodiment of the invention performs an end of day position roll to extract profit and loss (PL) for settlement and to roll the position to re-establish the position to the following day's spot. This is achieved by agreeing a mid-price for each instrument to which all members' positions are rolled against the central counterparty. The difference in the position to a base currency, typically US Dollars, is the PL to be settled with the central counterparty.

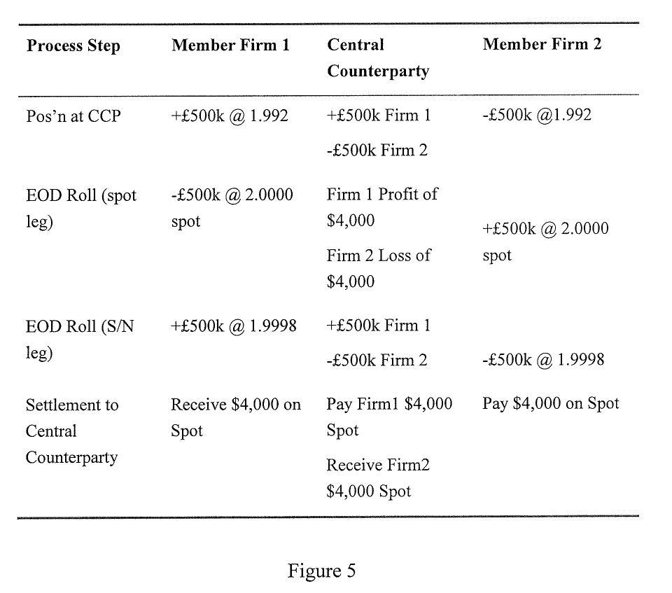

This position is illustrated in FIG. 5 which shows the positions after the settlement swap of FIG. 4. IT can be seen that overall firm 1 has a profit of $4,000 and firm 2 a loss of $4,000. The central counterparty therefore pays $4,000 to firm 1, but receives $4,000 from firm 2. However, the firms' positions are still carried at the central counterparty. In practice, this means that the firms' forward desks have to perform minimal funding activity and that the cost of trading is dramatically reduced.

Management of risk is central to the settlement process. The greatest risk to the central counterparty is that one of the parties with an open position will default and their positions will need to be closed. In the FX spot markets, this risk will remain for an average of two days. the biggest counterparty to the platform together with a contingent amount for any disruption of position/settlement caused by the failure of an institution. Part of this risk management requires a periodic review of the adherence of member firms to membership standards of the central counterparty. However, additional measures may be taken to control and reduce the counterparty's exposure to any member firm.

Firstly, member firms may be required to deposit an initial amount to establish trading lines. This account is used to offset mark-to-market movement of the firm's portfolio and may be leveraged to establish the net exposure the firm can establish at any time with the central counterparty.

Once initial lines and trading positions have been established, the central counterparty has two methods for exposure relief. The first and primary is margin which may be used to enable accumulation of larger currency positions with the central counterparty. The settlement swap may also be used by the central counterparty to provide exposure relief. The central counterparty retains the right to initiate a settlement swap to limit concentration risk of a particular firm to the settlement system or to a specific currency within each firm's position. In a situation where a firm is unwilling to provide margin support, a settlement swap may be executed to novate the counterparty exposure to other firms who have remaining credit support for bilateral trading.

A number of layers of protection may be enacted by the central counterparty if a member defaults. These layers cover the mark-to-market exposure on the member position while the position is closed out by the central counterparty.

The first layer of protection is provided by the deposit posted by the member firm. In one preferred embodiment this is set at a level expected to cover a 2% deterioration in performance of the portfolio against the PL currency which is typically $US together with pending firm payables to the central counterparty as a result of position rolls. The central counterparty assumes that access to capital will be required immediately during a default. Lines of credit may be established to facilitate rapid injection of capital into the organisation. The central counterparty may also establish a clearing fund. This fund acts as the working capital of the central counterparty and is maintained to ensure that it meets all its obligations in times of stress. This fund may be established through a variety of means, for example, through equity participation of member firms or through establishment of a guarantee fund should the parties agree to mutualise risk.

The embodiments described have a number of advantages over existing known settlement systems. By operating on the basis that there is no physical transfer of currencies, only a transfer of profit or loss, the system reflects the realities of modern day trading. However, the settlement swap mechanism permits a physical transfer without requiring a new instrument such as an NDF. The system reduces the cost of funding by forwards desks to maintain positions while reducing greatly the operational and settlement risks incurred by maintaining these positions. Moreover, the system does not require pre-funding in currencies other than the basic currency, typically $US, and provides continuous net settlement.

An additional advantage is that settlement is by position request per currency, allowing trading decisions to be based on liquidity and not settlement requirements. For example a client may have a need to buy CHF and sell USD but liquidity for CHF is much better in a EUR/CHF trade. If a firm then needs to physically settle the CHF with the client it can request a settlement swap in CHF against the common currency (USD) to meet this requirement provided the EUR/CHF trade was executed as an eligible settlement system trade. This is made possible by the NSP's always being maintained against a common currency in effect decomposing both sides of a trade to be against the common currency when one side of the trade is not that currency.

In the example given above, the EUR/CHF trade is decomposed into a EUR/USD position and a USD/CHF position and the settlement swap is against the common currency. Existing prior systems are not able to break the EUR/CHF position into USD legs, or more generally into legs against a common currency.

Many modifications to the embodiments are possible and will occur to those skilled in the art without departing from the invention which is defined by the following claims.

1. A post-trade settlement system for settlement of transactions, comprising a processor configured to perform the steps of:
receiving from trading parties trade related data identifying executed trades, the data including the counterparties to the trades, the items traded and the price and amount of the trades;
for each executed trade, matching trade related data received from counterparties to a trade to identify a matched trade between first and second counterparties; and novating the matched trade into a first novated trade between the first counterparty and the settlement system and a second novated trade between the second counterparty and the settlement system,
receiving a request from a counterparty to a novated trade for physical settlement of the trade, the amount indicating the amount to be physically settled;
determining a first and a second counterparty to the physical settlement;
moving an equal and opposite position from the settlement system to the first and second counterparties to the settlement request; and
transferring the amount of the physical settlement request from one of the counterparties to the physical settlement request to the other.

2. A system according to claim 1, wherein the transferring of the amount of the physical settlement request is performed as a trade at current market rate.

3. A system according to claim 1, wherein the settlement system performs a continuous net settlement of novated trades between a given counterparty and the settlement system.

4. A system according to claim 3, wherein the continuous net settlement is performed against a common currency irrespective of the currency of the transactions.

5. A system according to claim 1, wherein requests for physical settlement are received from a plurality of counterparties and the settlement system selects a counterparty to a physical settlement request from the plurality of counterparties submitting requests for physical settlement.

6. A system according to claim 1, wherein the request for physical settlement is received from a first counterparty and the central counterparty assigns the second counterparty to the physical settlement.

7. A system according to claim 1, wherein requests for physical settlement are received from a plurality of counterparties and the processor executes an algorithm to identify matching requests for physical settlement.

8. A method of post-trade settlement of transactions executed between parties, comprising the steps of:
receiving from counterparties to executed trades data identifying executed trades and including the counterparties to the trades, the items traded, the price and the amount of the trades;
for each executed trade, matching trade related data received from counterparties to a trade to identify a matched trade between first and second counterparties, and novating the matched trade into a first novated trade between the first counterparty and the settlement system and a second novated trade between the second counterparty and the settlement system,
receiving a request from a counterparty to a novated trade for physical settlement of the trade, the amount indicating the amount to be physically settled;
determining a first and a second counterparty to the physical settlement;
moving an equal and opposite position from the settlement system to the first and second counterparties to the settlement request; and
transferring the amount of the physical settlement request from one of the counterparties to the physical settlement request to the other.

9. A method according to claim 8, wherein the transferring of the amount of the physical settlement request is performed as a trade at current market rate.

10. A method according to claim 8, wherein the settlement system continuously nets settlement of novated trades between a given counterparty and the settlement system.

11. A method according to claim 10, wherein the continuous net settlement is performed against a common currency irrespective of the currency of the transactions.

12. A method according to claim 8 wherein requests for physical settlement are received from a plurality of counterparties and the settlement system selects a counterparty to a physical settlement request from the plurality of counterparties submitting requests for physical settlement.

13. A method according to claim 8, wherein the request for physical settlement is received from a first counterparty and the central counterparty assigns the second counterparty to the physical settlement.

14. A method according to claim 8, wherein requests for physical settlement are received from a plurality of counterparties and comprising executing an algorithm to identify matching requests for physical settlement.

15. A method according to claim 8, comprising periodically calculating the profit or loss of a counterparty with respect for other counterparties on the system and making a payment to or from the counterparty in respect of the profit or loss.

16. A method of post-trade clearing of transactions executed between counterparties, comprising the steps of:
receiving at a central counterparty from counterparties to executed trades data identifying executed trades and including the counterparties to the trades, the items traded, the price and the amount of the trades;
at the central counterparty, for each accepted executed trade, matching trade related data received from counterparties to a trade to identify a matched trade between first and second counterparties, and novating the matched trade into a first novated trade between the first counterparty and the settlement system and a second novated trade between the second counterparty and the settlement system, and
maintaining a continuous net settlement position for accepted trades for each counterparty with respect to the central counterparty, the net position being against a common currency regardless of the currency of the transaction.

17. A method according to claim 16, wherein the net settlement positions of each counterparty is rolled at the end of a settlement period and re-established in a following settlement period.

18. A method according to claim 17, wherein the rolling of the net settlement positions comprises rolling the positions against the central counterparty at a market mid-price and settling a differential in the position with respect to the common currency with each counterparty.
